(19) United States
(12) Patent Application Publication
(10) Pub. No.: US 2014/0042704 A1
(43) Pub. Date: Feb. 13, 2014

(54) SEAL ALIGNING AND RETAINING ASSEMBLY AND METHOD OF RETAINING A SEAL

(71) Applicant: GM GLOBAL TECHNOLOGY OPERATIONS LLC, Detroit, MI (US)

(72) Inventor: Joseph M. Polewarczyk, Rochester Hills, MI (US)

(73) Assignee: GM GLOBAL TECHNOLOGY OPERATIONS LLC, Detroit, MI (US)

(21) Appl. No.: 13/734,408

(22) Filed: Jan. 4, 2013

Related U.S. Application Data
(60) Provisional application No. 61/681,445, filed on Aug. 9, 2012.

(51) Int. Cl. F16J 15/02

(52) U.S. Cl. CPC F16J 15/02
USPC 277/312; 277/630

(57) ABSTRACT

A seal aligning and retaining assembly includes a seal trough defined by a first side wall, a second side wall and a base. Also included is at least one protrusion integrally formed with the base and extending therefrom, the at least one protrusion having an outer surface. Further included is a seal having at least one aperture including a first elastically deformable inner surface, the seal also having a first elastically deformable outer wall, the seal configured to elastically deform upon disposition of the seal in the seal trough at a first interface between the first elastically deformable inner surface and the outer surface of the at least one protrusion and at a second interface between the first elastically deformable outer wall and at least one of the first side wall and the second side wall.

### CROSS-REFERENCE TO RELATED APPLICATION

This application claims the benefit of U.S. Provisional Application Ser. No. 61/681,445, filed Aug. 9, 2012, which is hereby incorporated herein by reference in its entirety.

### FIELD OF THE INVENTION

The subject invention relates to seal assemblies, and more particularly to a seal aligning and retaining assembly, as well as a method of retaining a seal.

### BACKGROUND

Seal assemblies are employed in a wide variety of applications for sealing purposes. A vehicle, such as an automobile, is a common example of a system requiring numerous seal assemblies. Various attachment configurations have been attempted to provide effectively sealing, as well as suitable alignment and retaining of the seal to an interface. One common example includes the use of several mechanical features, such as a push pin, that is inserted into a receiving aperture of the seal. Unfortunately, due to manufacturing inaccuracies, significant positional variation tolerances of mechanical features of the interface and the receiving aperture of the seal may contribute to large and varying gaps and otherwise a poor fitted relationship between the seal and the interface. Such variance results in poor sealing and may allow for the introduction of dirt, contaminants, and foreign objects.

### SUMMARY OF THE INVENTION

In one exemplary embodiment of the invention, a seal aligning and retaining assembly includes a seal trough defined by a first side wall, a second side wall and a base. Also included is at least one protrusion integrally formed with the base and extending therefrom, the at least one protrusion having an outer surface. Further included is a seal having at least one aperture including a first elastically deformable inner surface, the seal also having a first elastically deformable outer wall, the seal configured to elastically deform upon disposition of the seal in the seal trough at a first interface between the first elastically deformable inner surface and the outer surface of the at least one protrusion and at a second interface between the first elastically deformable outer wall and at least one of the first side wall and the second side wall.

In another exemplary embodiment of the invention, a method of retaining a seal is provided. The method includes aligning an aperture of the seal with at least one protrusion disposed in a seal trough, the seal trough defined by a first side wall, a second side wall and a base. Also included is disposing a first side region of the seal between the first side wall and the at least one protrusion. Further included is elastically deforming the first side region upon disposal of the first side region of the seal between the first side wall and the protrusion.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a seal interface;

FIG. 2 is a cross-sectional view of a seal for mating with the seal interface; and

FIG. 3 is a flow diagram illustrating a method of retaining a seal.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

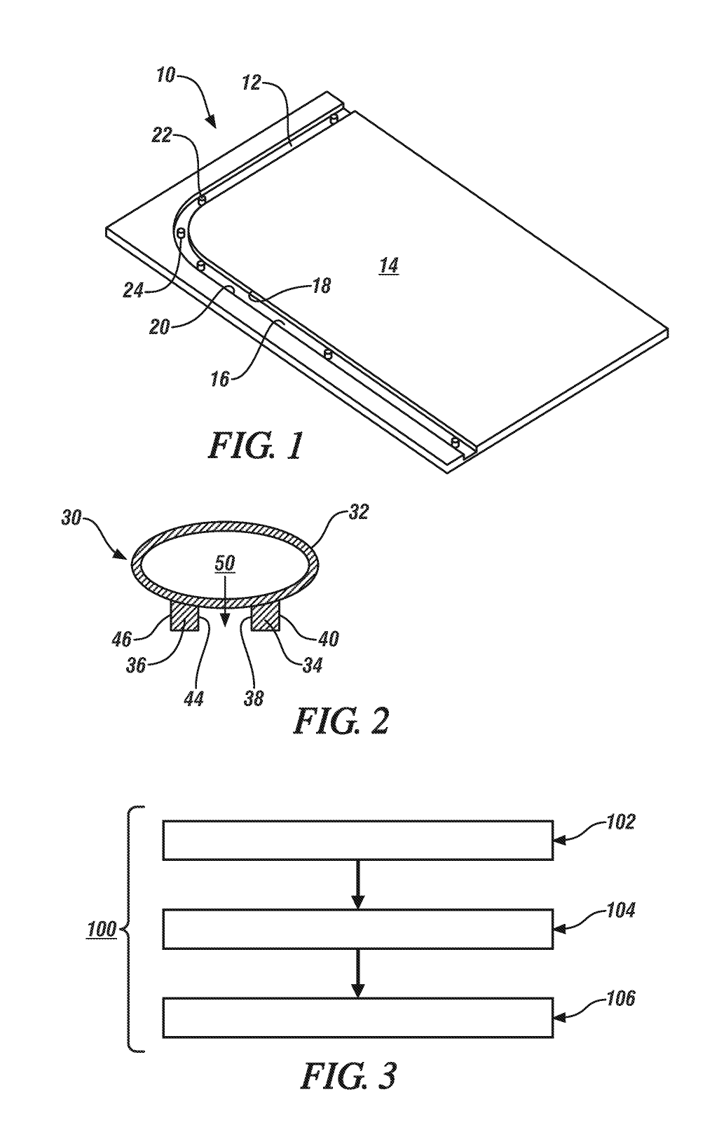

Referring to FIG. 1, a seal interface is illustrated and generally referred to with numeral 10. The seal interface 10 may be disposed in a variety of applications, such as for a vehicle. In one exemplary embodiment, the seal interface 10 comprises a battery tray in an automobile for sealing to a portion of a vehicle body (not illustrated), however, it is to be appreciated that the seal interface 10 may be employed in conjunction with numerous applications within an automobile. The seal interface 10 is typically formed in a casting process and may comprise various materials, such as aluminum, for example. It is contemplated that the seal interface 10 is formed of any metal or plastic, however, these materials are merely illustrative and not intended to be limiting.

The seal interface 10 includes a seal trough 12 extending along a first surface 14 of the seal interface 10. The seal trough 12 may extend in various orientations and may be of varying depths and lengths within the first surface 14. In the illustrated embodiment, the seal trough 12 is substantially C-shaped. The seal trough 12 is defined by a base 16, a first side wall 18 and a second side wall 20. The seal trough 12 includes at least one, but typically a plurality of protrusions 22 each extending away from the base 16. The plurality of protrusions 22 may be integrally formed with the seal interface 10, such as during the casting process noted above for a cast embodiment. Additionally, the plurality of protrusions 22 may be spaced from one another along the seal trough 12 at equal distances or may be disposed in a staggered alignment with varying distances separating the plurality of protrusions 22. As shown in the illustrated embodiment, the plurality of protrusions 22 may be tubular in shape defined by an outer surface 24. It is to be appreciated that the plurality of protrusions 22 may be of various other geometric shapes, but irrespective of the geometric shape of the protrusions 22, the outer surface 24 is present. In an exemplary embodiment, the plurality of protrusions 22 are hollow, with the outer surface 24 being relatively stiff. The protrusions 22 are integrally formed with the seal trough 12, such that the protrusions 22 may be formed of any suitable material, including a metal or plastic, as described above in relation to the seal interface 10 as a whole. As noted above, the material of the protrusions 22 is not limited to the examples noted herein.

Referring now to FIG. 2, a cross-sectional view of a seal 30 is illustrated. The seal 30 may be of various dimensions and geometric configurations, with an exemplary embodiment illustrated as a ring-like shape. The seal 30 includes a main bulb portion 32 terminating at each end with a first longitudinally extending side region 34 and a second longitudinally extending side region 36. The first longitudinally extending side region 34 includes a first elastically deformable inner surface 38 and a first elastically deformable outer wall 40. The second longitudinally extending side region 36 includes a second elastically deformable inner surface 44 and a second elastically deformable outer wall 46. The first elastically deformable inner surface 38 and the second elastically deformable inner surface 44 define, at least in part, an aperture 50 that is configured to receive at least one of the plurality of protrusions 22 extending from the base 16 of the seal trough 12.

As an alternative to a single aperture formed by the first longitudinally extending side region 34 and the second longitudinally extending side region 36, a plurality of apertures may be included and are disposed in a one-to-one correspondence with the plurality of protrusions 22. Specifically, for each protrusion there is an aperture. It is to be appreciated that the aperture 50 may be formed in numerous geometric shapes, with one such shape comprising a hole or slot. Irrespective of the shape of the aperture 50 and whether a single aperture or a plurality of apertures is employed, the aperture 50 includes a shape substantially corresponding to that of the plurality of protrusions 22. In an exemplary embodiment, the aperture 50, and more specifically, the first elastically deformable inner surface 38 and the second elastically deformable inner surface 44, has elastic properties so as to deform elastically without fracture. The first longitudinally extending side region 34 and the second longitudinally extending side region 36 include material that is resiliently reversible in response to a compressive force being applied thereto.

The seal 30 generally, and more particularly the first longitudinally extending side region 34 and the second longitudinally extending side region 36 may be formed of various materials, such as metal or plastic for example, however, numerous other materials are contemplated.

The cross-section, such as a diameter or width, of each of the protrusions 22 exceeds a cross-section, such as a width or perimeter, of the aperture 50. Upon alignment and insertion of the plurality of protrusions 22 into the aperture 50, elastic deformation of one or more of the above-described components occurs to accommodate the larger protrusions. The elastic deformation of at least one of the first longitudinally extending side region 34 and the second longitudinally extending side region 36 elastically averages any positional errors of the seal 30 and the seal interface 10. In other words, gaps that would otherwise be present due to positional errors associated with portions or segments of the seal 30 and the seal interface 10 are eliminated by offsetting the gaps with an over-constrained condition along other portions or segments of the seal 30 and the seal interface 10. The principles of elastic averaging are described in detail in commonly owned, co-pending U.S. patent application Ser. No. 13/187,675, the disclosure of which is incorporated by reference herein in its entirety. The elastic deformation may occur in numerous regions, with such regions including a first interface and a second interface. The first interface is between the first elastically deformable inner surface 38 and the outer surface 24 of the plurality of protrusions 22. The second interface is between the first elastically deformable outer wall 40 of the first longitudinally extending side region 34 and the first side wall 18 of the seal trough 12. Similarly, an interface is present between the second elastically deformable outer wall 46 of the second longitudinally extending side region 36 and the second side wall 20 of the seal trough 12.

While the protrusions 22 have been illustrated and described above as being operably coupled to, or integrally formed with, the seal trough 12 of the seal interface 10, and the aperture 50 has been illustrated and described above as being formed in the seal 30, it is to be understood that the opposite may be true in an alternative embodiment. Specifically, the seal interface 10 may include apertures, while the seal 30 includes protrusions. Yet other embodiments may include a combination of the two embodiments, such that either or both the seal interface 10 and the seal 30 include apertures and protrusions. It is also contemplated that the protrusions 22 may be elastic in nature, to provide additional elasticity to the overall retaining structure.

Advantageously, the elastic deformation of various components described above provide a positioning and retaining relationship between the seal 30 and the seal interface 10, while ensuring a tight, fitted relationship between all components associated with the seal 30 and the seal interface 10. The elastic nature of the components alleviates positional variance of various fastening devices due to manufacturing.

A method of retaining a seal 100 is also provided as illustrated in FIG. 3 and with reference to FIGS. 1 and 2. The vehicle seal 30 and seal interface 10 have been previously described and specific structural components need not be described in further detail. The method of retaining a seal 100 includes aligning 102 the aperture 50 of the seal 30 with the protrusion 22. The first longitudinally extending side region 34 is disposed 104 between the first side wall 18 and the protrusion 22. Upon disposal of the first longitudinally extending side region 34 between the first side wall 18 and the elastic protrusion 22, the first longitudinally extending side region 34 is elastically deformed 106, thereby frictionally retaining the seal 30 within the seal trough 12.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A seal aligning and retaining assembly comprising:
a seal trough defined by a first side wall, a second side wall and a base;
at least one protrusion integrally formed with the base and extending therefrom, the at least one protrusion having an outer surface; and
a seal having at least one aperture including a first elastically deformable inner surface, the seal also having a first elastically deformable outer wall, the seal configured to elastically deform upon disposition of the seal in the seal trough at a first interface between the first elastically deformable inner surface and the outer surface of the at least one protrusion and at a second interface between the first elastically deformable outer wall and at least one of the first side wall and the second side wall.

2. The seal aligning and retaining assembly of claim 1, further comprising:
a first side region including the first elastically deformable inner surface and the first elastically deformable outer wall, the second interface between the first elastically deformable outer wall and the first side wall; and
a second side region including a second elastically deformable inner surface and a second elastically deformable outer wall.

3. The seal aligning and retaining assembly of claim 2, the seal configured to elastically deform at a third interface between the second elastically deformable inner surface and the outer surface of the at least one protrusion and at a fourth interface between the second elastically deformable outer wall and the second side wall.

4. The seal aligning and retaining assembly of claim 3, wherein elastic deformation proximate at least one of the first interface, the second interface, the third interface, and the fourth interface frictionally retains the seal within the seal trough.

5. The seal aligning and retaining assembly of claim 1, wherein the seal trough is disposed in a battery tray for sealing to a vehicle body.

6. The seal aligning and retaining assembly of claim 1, wherein the base is aligned relatively perpendicularly to the first side wall and the second side wall.

7. The seal aligning and retaining assembly of claim 1, wherein the trough is relatively C-shaped and includes a relatively continuous curvature between the first side wall, the second side wall and the base.

8. The seal aligning and retaining assembly of claim 1, further comprising a protrusion width and an aperture width, wherein the protrusion width is greater than the aperture width.

9. The seal aligning and retaining assembly of claim 1, wherein the protrusion comprises a plastic material.

10. The seal aligning and retaining assembly of claim 1, wherein the first side wall and the second side wall comprise a plastic material.

11. The seal aligning and retaining assembly of claim 1, wherein the protrusion comprises a metal material.

12. The seal aligning and retaining assembly of claim 1, wherein the first side wall and the second side wall comprise a metal material.

13. A method of retaining a seal comprising:
aligning an aperture of the seal with at least one protrusion disposed in a seal trough, the seal trough defined by a first side wall, a second side wall and a base;
disposing a first side region of the seal between the first side wall and the at least one prostrusion; and
elastically deforming the first side region upon disposal of the first side region of the seal between the first side wall and the at least one protrusion.

14. The method of claim 13, further comprising disposing a second side region of the seal between the second side wall and the at least one protrusion to elastically deform the second side region and the at least one protrusion.

15. The method of claim 14, further comprising inserting a protrusion width into an aperture width defined by the first side region and the second side region of the seal, wherein the protrusion width is greater than the aperture width, thereby constraining at least one of the first side region and the second side region to accommodate positional variance of the seal.

16. The method of claim 13, wherein elastically deforming the first side region at least one protrusion frictionally retains the seal within the seal trough.
